(19) United States
(12) Patent Application Publication
(10) Pub. No.: US 2015/0039446 A1
(43) Pub. Date: Feb. 5, 2015

(54) OBTAINING REAL-TIME ADVERTISEMENT FEE PAYMENTS

(71) Applicant: Alibaba Group Holding Limited, George Town (KY)

(72) Inventors: Kai Wang, Hangzhou (CN); Fang Wang, Hangzhou (CN)

(21) Appl. No.: 14/340,346

(22) Filed: Jul. 24, 2014

(30) Foreign Application Priority Data
Jul. 31, 2013 (CN) 201310329535.9

(51) Int. Cl. G06Q 30/02

(52) U.S. Cl. CPC G06Q 30/0273; G06Q 40/025
USPC 705/14.69; 705/38; 705/14.73

(57) ABSTRACT

Obtaining real-time advertisement fee payments is disclosed, including: receiving access behavior data from a publisher server, wherein the access behavior data comprises data associated with interactions associated with one or more ads associated with an advertiser; determining a loan amount based at least in part on total ad fees determined based at least in part on the access behavior data; generating a loan processing request including at least the loan amount; and sending the loan processing request to a loan management server, wherein the loan management server is configured to determine whether the loan amount is authorized for the advertiser based at least in part on a loan processing agreement associated with the advertiser.

### CROSS REFERENCE TO OTHER APPLICATIONS

This application claims priority to People's Republic of China Patent Application No. 201310329535.9 entitled A DATA PROCESSING METHOD AND SYSTEM, filed Jul. 31, 2013 which is incorporated herein by reference for all purposes.

### FIELD OF THE INVENTION

The present invention relates to the field of Internet advertisements. Specifically, the present application relates to techniques for obtaining payment of fees associated with running advertisements.

### BACKGROUND OF THE INVENTION

In the Internet age, the amount of Internet data that is collected and in need of processing increases daily. In particular, the pressure of data collecting and processing associated with large-scale, real-time user behavior and their behavior data is also increasing daily. Internet real-time data volumes are enormous in comparison with data processing in the past. This fact, combined with security and authentication restrictions on collected data, the complexity of data sources, and other such factors, means that the processing of large-scale, real-time data processing is becoming increasingly difficult. Internet advertising services that employ cost per click (CPC) (or pay per click, PPC) technology or services that provide priority/high-frequency presentation of information on web pages in accordance with search keywords, for example, involve huge volumes of network data including data associated with user interactions with respect to online advertisements. Data associated with engagement of online advertisements often requires real-time processing, which may be difficult to accomplish.

The following describes an example conventional system for billing advertisers for CPC advertising services: CPC involves billing an advertiser for each user click on one of that advertiser's advertisements that is displayed at a web page. Sometimes, safeguards (e.g., click-rate restrictions) are put in place (e.g., by advertisers and/or the publisher) to prevent fraudulent clicks from being included in the fee calculations and to ensure that all collected clicks are most likely non-fraudulent. The use of CPC technology to keep track of online advertisement billing is a common approach in countries where the Internet usage is more mature. At present, the traditional Internet advertising business approach primarily utilizes this CPC model. CPC is a marketing/promotional tool for the recipient of the service, such as the advertiser. The advertising service provider, such as an advertising agency, designs and creates advertisements that can be presented and accessed through web pages. Advertisements may include images, sponsored search results, text, navigation, and keyword input boxes that can be accessed/clicked/interacted with. Publishers can provide such advertisements to users by displaying the advertisements at websites.

Generally, in a CPC model, an advertiser needs to deposit funds into an account from which future incurred advertisement costs/fees will be deducted. For example, the account may be managed by the advertising service provider. For example, the advertising service provider can count the number of times that users click on that advertiser's advertisements at the publisher's website. That is, the advertising service provider can track user interactions with the advertisements. In a CPC model, the advertiser is charged a fee (e.g., that is fixed or dynamically determined) per each user click to the advertiser's advertisements. As such, for each user click on the advertiser's advertisements, a corresponding fee is to be deducted from the advertiser's advance deposit account and to be paid to the publisher of the advertisements (and/or another entity). Once the funds in the account are depleted, the advertiser's advertisements will no longer be displayed at the publisher's website, which could be undesirable if the advertiser had intended for the advertisements to be displayed for a longer period. As such, the advertiser has an interest to keep enough funds in the advertiser's account such that the advertiser's advertisements will continue to run for the duration of the advertisement campaign.

However, the use of the advance deposit payment method to pay for CPC fees may be disadvantageous for the advertiser because due to the unpredictability of user traffic to the publisher's website, it is difficult to forecast an appropriate amount of funds to advance deposit into the account. On one hand, if an advertiser advance deposits too much funds into its account and a large portion of the funds are left over after the advertisement fees are deducted, then the advertiser loses out on the opportunity to have applied the excess funds to other uses. In addition, if the advertiser had loaned the funds that were advance deposited into the account, then the advertiser would need to initiate a potentially complicated process of returning the borrowed funds back to the lender. On the other hand, if the advertiser advance deposits too little funds into its account, the advertiser's advertisements may be suspended from display prior to the desired end time of the advertisement campaign. As such, the conventional technique of paying for CPC advertisements is cumbersome and inefficient.

In a different advertising context, an advertiser may pay fees to a search engine or other type of entity that returns search results for a user submitted search query to increase the priority of the advertiser's search results among the other search results. This way, the advertiser's search results (e.g., links) may enjoy greater exposure to the searching user and may receive more traffic. A fee may be deducted from the advertiser's account for each of the advertiser's search results that is displayed in a prioritized manner and paid to the search engine (e.g., and/or other entity). Because, conventionally, the same type of advance deposit as described above is used to pay for the advertisement fees incurred for prioritized search results, paying for prioritizing search results suffers from the same problems as described above.

### BRIEF DESCRIPTION OF THE DRAWINGS

Various embodiments of the invention are disclosed in the following detailed description and the accompanying drawings.

FIG. 1 is a diagram showing an embodiment of a system for obtaining real-time advertisement fee payments.

FIG. 2 is a flow diagram showing an embodiment of a process for obtaining real-time advertisement fee payments.

FIG. 3 is a flow diagram showing an example of a process for collecting access behavior data.

FIG. 4 is a flow diagram showing an example of a process for generating a loan processing request.

FIG. 5 is a flow diagram showing an example of a process for processing a loan processing request.

FIG. 6 is a flow diagram showing an embodiment of obtaining real-time advertisement fee payments.

FIG. 7 is a functional diagram illustrating an embodiment of a programmed computer system for implementing obtaining real-time advertisement fee payments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Embodiments of obtaining real-time advertisement fee payments are described herein. In various embodiments, an advertising management server is configured to facilitate an advertiser (or another entity associated with paying for advertisements) in obtaining real-time advertisement fee payments owed to a publisher (e.g., and/or other entity associated with publishing the advertisements and/or receiving ad fees). For example, the advertising management server is associated with an advertising agency or an advertising management service associated with running advertisement campaigns on behalf of advertisers. In various embodiments, an “advertisement” is sometimes referred to as an “ad.” Examples of types of ads include image-based ads, sponsored search results, text-based ads, and video ads. In various embodiments, the advertising management server is configured to track the access behavior data associated with one or more ads displayed/served at the publisher. In various embodiments, “access behavior data” associated with ads refers to data pertaining to various different user and/or publisher initiated events/interactions with the ads, where each access behavior causes a fee to be charged to the advertiser (e.g., and to be paid to the publisher and/or any other entities). For example, user access behavior data associated with the ads includes data pertaining to user selections (e.g., number of clicks, time of clicks) on ads and displays by the publisher of sponsored search results.

The advertising management server is configured to (e.g., periodically) determine the total ad fees owed by the advertiser (e.g., to one or more publishers and/or other entities) based on the access behavior data (e.g., collected over a preset period). In some embodiments, the advertising management server can maintain an account with funds deposited in advance by the advertiser. If the advertiser has such an advance deposit account with the advertising management server, then the advertising management server can withdraw funds from the account to pay for the total ad fees. However, in the event that the advertiser has not set up an advance deposit account and/or the funds in an existing account have been depleted, the advertising management server is configured to send a loan processing request to a loan management server. For example, the loan management server can be associated with a financial institution such as a credit card company or a bank. The loan processing request includes an identifier associated with the advertiser for which the loan is requested and an amount of funds that is determined to be equivalent to at least the amount needed to cover whatever of the total ad fees that could not be covered with funds remaining in that advertiser's advance deposit account. The advertising management server is configured to receive a response from the loan management server that indicates whether the requested loan has been authorized and if so, data related to a transfer of the funds associated with the requested loan. The data related to a transfer of the funds associated with the requested loan may include instructions (e.g., computer code) usable by the advertising management server to retrieve and transfer the loaned funds to an account associated with the publisher (and/or other entity) on behalf of the advertiser. As such, the total ad fees owed by the advertiser may be paid based on funds from the advertiser's advance deposit account, funds loaned from the loan management server, or a combination of funds withdrawn from the advertiser's advance deposit account and loaned from the loan management server.

As will be described in further detail below, in various embodiments described herein, the advertising management server can determine in approximately real-time whether a loan is needed to cover any portion of total ad fees owed by an advertiser to a publisher (e.g., and/or other entity) beyond funds that are available in the advertiser's advance deposit account. If the advertising management server determines that a loan is needed, then the advertising management server can request a loan from a loan management server to pay the outstanding total ad fees and ensure that the advertiser's ads are not suspended at the publisher's website(s) on account of a lack of funds in the advertiser's advance deposit account and/or any unpaid ad fees owed by the advertiser. The advertising management server can facilitate a smooth and uninterrupted run of an advertiser's ad campaign without requiring the advertiser to correctly predict an appropriate amount of funds to maintain/add into its advance deposit account.

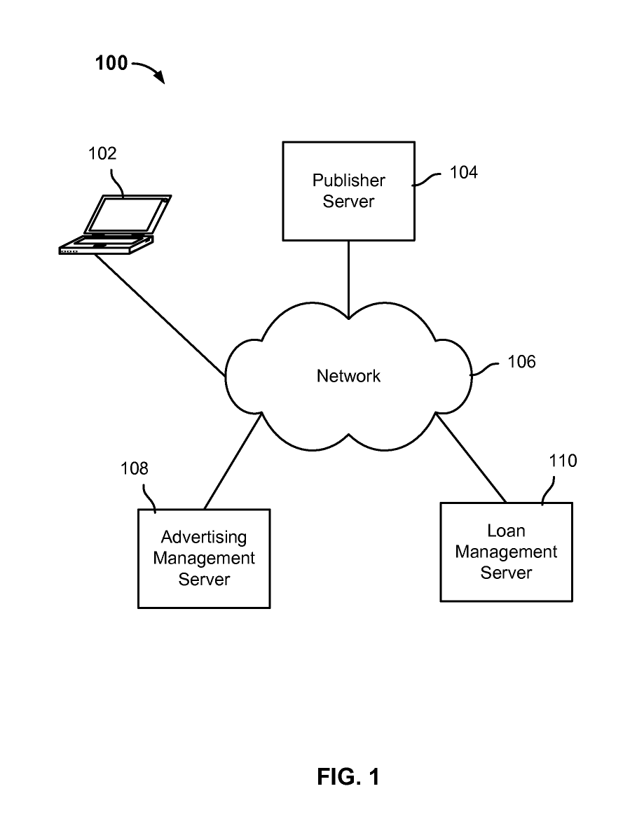

FIG. 1 is a diagram showing an embodiment of a system for obtaining real-time advertisement fee payments. In the example, system 100 includes client device 102, publisher server 104, network 106, advertising management server 108, and loan management server 110. Network 106 includes high-speed data networks and/or telecommunications networks. Each of publisher server 104, advertising management server 108, and loan management server 110 can be implemented as an individual server or as a cluster of servers.

The following terms apply to various embodiments of implementing system 100:

“Advertiser” refers to any entity that has an arrangement with one or more publishers and/or advertising management services to serve its ads and to pay a fee for each interaction initiated by and/or with respect to a user and/or publisher with respect to its ads.

“Advertisements” or “ads” refer to objects that are displayed by a publisher website. An advertiser and/or an advertising management service may create ads. Examples of ads may include image-based ads, sponsored search results, text-based ads, and video ads. A user and/or publisher interaction/generated event associated with an ad may cause a fee to be charged to the advertiser associated with the ad. For example, the ads may be generated by the advertisers and/or an advertising management service working on behalf of the advertisers.

A first example type of a publisher website at which an advertiser may advertise is an e-commerce website. For example, the e-commerce website may display one or more ads among its home page and/or its product profile pages. For example, each user selection with a displayed ad of an advertiser causes a fee to be charged to the advertiser. A second example type of a publisher website at which an advertiser may advertise is a search engine website. For example, the search engine may return a set of search results to a user in response to a user submitted search query and one or more ads that comprise sponsored search results (e.g., that match the search query) can be displayed in a prioritized manner (e.g., at a higher ranked position) among the ranked search results. For example, each time that the search engine displays a sponsored search result (e.g., at a particular prioritized/high ranking) among the ranked search results, a fee is charged to the advertiser.

“Access behaviors” associated with ads refer to various different user and/or publisher initiated events/interactions with the ads at publisher websites, each of which causes a fee to be charged to the advertiser (e.g., to be paid to the publisher and/or any other entities). In a first example, in the CPC model, an access behavior includes a user selection (e.g., click) of a displayed ad, which may cause a fee to be charged to its advertiser. In a second example, an access behavior includes a presentation of a sponsored search result among search results by the search engine publisher, which may cause a fee to be charged to its advertiser. In various embodiments, access behavior data is collected/received by a publisher server associated with the publisher websites and sent to an advertising management server associated with an advertising management service responsible for obtaining fee payments on behalf of the advertiser.

“Total ad fees” refer to a total amount of fees charged to an advertiser based on the collected access behaviors (e.g., over specific period) with respect to that advertiser's ads and predetermined fee rates associated with respective types of access behaviors. For example, a predetermined fee rate indicates that each instance of access behavior A causes a fee of B to be charged to the associated advertiser. The total ad fees can be paid to the publisher and/or split among the publisher and another entity (e.g., the advertising management service). The total ad fees owed by an advertiser may be determined and collected, periodically. In some embodiments, the total ad fees owed by the advertiser to the publisher and/or another entity is determined by the advertising management server based on the access behavior data collected by the publisher server with respect to ads associated with the advertiser. In some embodiments, the fee payments to cover the total ad fees owed by the advertiser are obtained and made on behalf of the advertiser by the advertising management server. In various embodiments, if the total ad fees owed by an advertiser are not paid by or on behalf of the advertiser (e.g., by a specified deadline), then the publisher server will (e.g., be instructed to) suspend presentation of that advertiser's ads.

A “loan amount” refers to an amount of funds that is needed by an advertiser to pay for at least a portion of the total ad fees owed by the advertiser to a publisher and/or another entity (e.g., the advertising management service). For example, the loan amount may comprise the total ad fees less any funds remaining in the advertiser's advance deposit account maintained by the advertising management server. The advertising management server can first determine whether the advertiser has enough funds remaining in its advance deposit account to cover the total ad fees. If there are insufficient funds remaining in the advance deposit account, then the advertising management server computes a loan amount as the difference between the total ad fees and the remaining funds in the advance deposit account. For example, if the third party loan management server is associated with a credit card company, then the loan amount may also be referred to as a “credit payment charge.”

A “loan processing request” refers to a request sent (by the advertising management server) to a third party loan management server to obtain a loan on behalf of an advertiser. In various embodiments, the loan management server is associated with a third party financial institution such as a credit card company or a bank. In some embodiments, a loan processing request includes at least an identifier associated with the advertiser for which the loan is requested and a desired loan amount. The loan management server can process the loan processing request to determine whether the loan amount should/can be issued to the advertiser (e.g., to help pay for any remaining outstanding ad fees owed by the advertiser to a publisher and/or other entity). In some embodiments, the advertising management server sends loan processing requests to the third party loan management server. In some embodiments, a loan processing request is implemented as an HTTP request and/or an XML document.

A “loan processing agreement” refers to a loan processing agreement established between a third party financial institution and an advertiser. In some embodiments, a loan management server associated with a financial institution stores the valid loan processing agreements that the financial institution has established with corresponding advertisers. The loan processing agreement between an advertiser and the financial institution will enable the advertiser to borrow/receive loans from the loan management server associated with the financial institution based on one or more terms of the agreement.

A “preset loan limit” refers to a credit line or any other type of limit on loaned funds that can be extended to an advertiser. In some embodiments, the preset loan limit is a term included in a loan processing agreement established by a third party financial institution and the advertiser.

An “identifier” refers to a piece of information that can be used to (e.g., uniquely) identify a particular advertiser and/or a loan processing agreement established by an advertiser and a financial institution. For example, an identifier can be a loan processing agreement signal or a loan processing agreement tag. In some embodiments, the identifier is generated by a loan management server. In some embodiments, the loan management server stores the identifier and also sends a copy of the identifier to the advertising management server for the advertising management server to store.

Publisher server 104 is associated with one or more publishers. Publisher server 104 is configured to display one or more types of ads (e.g., image-based ads, sponsored search results, text-based ads, and video ads) at one or more websites that it operates. Examples of websites operated by publisher server 104 include an e-commerce website and/or a search engine website. Client device 102 is configured to be used by one or more users to access the websites operated by publisher server 104. Publisher server 104 is configured to detect, collect, and store various types of access behavior data with respect to ads displayed at website(s) operated by publisher server 104. In some embodiments, publisher server 104 is configured to store data/records including the relevant advertiser and the type of access behavior with each access behavior. A first example of access behavior data comprises user interactions with the displayed ads. For example, users may access the websites using web browser applications executing at client device 102. For example, users may interact with the various ads presented at the websites. Example user interactions include selecting (e.g., clicking on) ads (e.g., images, text, videos), inputting search queries, and selecting (e.g., clicking on) search results. A second example of access behavior data comprises publisher initiated events. For example, a search engine publisher can display an ad comprising a sponsored search result in a prioritized location among the other search results matching a user submitted search query. In various embodiments, publisher server 104 is configured to send the collected access behavior data to advertising management server 108.

Advertising management server 108 is associated with an advertisement management service. Advertising management server 108 is configured to perform payments of ad fees owed by one or more advertisers (not shown in the diagram) on behalf of the advertisers to one or more publishers (e.g., associated with publisher server 104) (and/or any other entities with respect to ads). In some embodiments, advertising management server 108 may store one or more of, but not limited to, the following: advertiser identifiers, one or more ads associated with each advertiser, access behavior data with respect to each advertiser's ad(s), total ad fees charged to each advertiser (e.g., based at least in part on the access behavior data with respect to each advertiser's ad(s)), and one or more loan amounts obtained for each advertiser. One or more ads of the advertiser may be displayed at the publishers' websites and (e.g., based on a set of predetermined fee rates) a fee (e.g., of a fixed amount or a dynamically determined amount) may be charged to the advertiser for each user selection/event (e.g., user click) and/or publisher event (e.g., display) of each of the advertiser's ads.

Advertising management server 108 is configured to determine the total ad fees to be paid on behalf of each advertiser based on access behavior data collected by and received from publisher server 104. For example, each instance of a type of access behavior with respect to an advertiser may be associated with a certain fee that is determined based on a set of predetermined fee rates. To determine the total ad fees owed by the advertiser to a publisher, advertising management server 108 can count each instance of each type of access behavior (e.g., user clicks) and multiply the total count with the predetermined fee (e.g., $0.01 per user click) associated with that type of access behavior. Then, advertising management server 108 can sum up the ad fees computed for each different type of access behavior to determine the total ad fees owed by the advertiser to the publisher associated with publisher server 104 and/or another entity.

In some embodiments, advertising management server 108 is configured to apply a set of predetermined filter rules to the access behavior data received from publisher server 104 to determine whether any portion of the access behavior data should be filtered out. For example, a filter rule may comprise a pattern associated with a fraudulent access behavior and can be used to match potentially fraudulent access behaviors from the data received from publisher server 104. Any access behavior data that is determined to match filter rules can be considered as potentially fraudulent and discarded. Then, the total ad fees may be determined based on the remaining access data behaviors, which are assumed to be non-fraudulent. The filtering of potentially fraudulent access behavior data can maintain the credibility of access behavior data on which the total ad fees are determined.

Advertising management server 108 determines whether any amount of funds (a “loan amount”) needs to be loaned from a financial institution (e.g., associated with loan management server 110) to cover any portion of the total ad fees owed by the advertiser to the publishers (and/or others). Advertising management server 108 can generate a loan processing request (e.g., an HTTP request and/or an XML document) to send to loan management server 110, where the loan processing request includes the determined loan amount and an identifier associated with the advertiser. In some embodiments, the identifier associated with the advertiser is generated by loan management server 110 based on a loan processing agreement established between the advertiser and a third party financial institution associated with loan management server 110. As mentioned above, the identifier associated with the advertiser may comprise a signal and/or tag associated with that loan processing agreement.

Because advertising management server 108 stores identifiers associated with advertisers, advertising management server 108 can look up among the stored identifiers whether an identifier is stored for an advertiser for which a loan processing request is to be generated. If advertising management server 108 cannot find a stored identifier associated with an advertiser, in some embodiments, advertising management server 108 sends stop instructions (e.g., computer code) associated with the advertiser to publisher server 104. The stop instructions are configured to instruct publisher server 104 to suspend/halt the display of any ads associated with the advertiser until further notice. In response to receiving the stop instructions from advertising management server 108, publisher server 104 will suspend the display of any ads associated with the advertiser. Furthermore, if advertising management server 108 cannot find a stored identifier associated with an advertiser, in some embodiments, advertising management server 108 sends to a device associated with the advertiser (not shown in system 100) a prompt configured to establish a valid loan processing agreement between the advertiser and the third party financial institution associated with loan management server 110. For example, the prompt may comprise a user interface and/or a URL/link directed to a web page presenting a predetermined agreement with a control (e.g., an “Agree” button), which if selected (e.g., by a user associated with the advertiser) establishes a valid loan processing agreement between the advertiser and the financial institution. In some embodiments, advertising management server 108 may have received the data associated with the prompt from loan management server 110. If the advertiser does not accept/establish the loan processing agreement and/or cannot pay the total ad fees, then the advertiser's ads will no longer be displayed by publisher server 104. After a user associated with the advertiser selects the control (e.g., the “Agree” button) of the prompt, loan management server 110 stores the loan processing agreement and generates/stores an identifier (e.g., using a portion of the agreement) for the advertiser. In various embodiments, a loan processing agreement includes a preset loan limit (e.g., a credit line) associated with the advertiser. For example, the preset loan limit may be determined based on specific attributes of the advertiser and/or a fixed value. Loan management server 110 sends the newly generated identifier to advertising management server 108, which stores the identifier associated with the advertiser. Once advertising management server 108 has stored the identifier, advertising management server 108 can generate loan processing requests for the advertiser associated with the identifier.

In some embodiments, advertising management server 108 determines a loan amount to include in a loan processing request for an advertiser equal to the total ad fees owed by the advertiser to one or more publishers (and/or to other entities). For example, if advertising management server 108 determines that the total ad fees owed by advertiser ABC is $1,000, then the loan amount included in the loan processing request is $1,000. In some embodiments, prior to determining the loan amount for an advertiser, advertising management server 108 checks whether the advertiser has established an advance deposit account with advertising management server 108 and if so, whether there are any funds remaining in the account. In the event that there are funds in the advertiser's advance deposit account, advertising management server 108 deducts funds from the account to pay for at least a portion of the total ad fees. If there are insufficient funds to cover the total ad fees, then advertising management server 108 determines the total ad fees less the remaining funds in the advertiser's advance deposit account as the loan amount. Whereas in a conventional system, if the advertiser's advance deposit account becomes depleted, the advertiser's ads are prevented from being displayed, embodiments described herein enable a loan to be obtained on behalf of the advertiser and to be used to ensure the uninterrupted display of ads at the publisher's websites. For example, if advertising management server 108 determines that the total ad fees owed by advertiser ABC is $1,000 and that there is $200 remaining in advertiser ABC's advance deposit account, then the loan amount included in the loan processing request is $1,000−$200=$800. In some embodiments, advertising management server 108 transfers the portion of funds from the advertiser's advance deposit account directly to an account associated with publisher server 104 (and/or another account associated with another entity) to pay for at least a portion of the advertiser's outstanding total ad fees.

Loan management server 110 is associated with a third party financial institution such as, for example, a credit card company or a bank. Loan management server 110 is configured to receive loan processing requests from advertising management server 108 on behalf of one or more advertisers (e.g., and/or other entities that help pay ad fees) for loans (e.g., to be paid to an account associated with publisher server 104 to cover outstanding ad fees). As described above, a loan processing request received from advertising management server 108 includes an advertiser identifier and a loan amount. Loan management server 110 extracts the advertiser identifier from the loan processing request. Loan management server 110 first determines whether the identifier matches an identifier stored by loan management server 110. As described above, if an advertiser has established a loan processing agreement with the financial institution associated with loan management server 110, then loan management server 110 stores the loan processing agreement and an identifier associated with the advertiser and also provides the identifier for advertising management server 108 to store. As such, if loan management server 110 determines that the identifier included in a loan processing request matches a stored identifier, then loan management server 110 determines that the advertiser associated with the loan processing request is a party with whom a loan processing agreement has previously been established and is therefore an authorized, credible party for whom the loan processing request can be processed.

If loan management server 110 determines that the advertiser associated with the loan processing request is a party with whom a loan processing request has previously been established, loan management server 110 retrieves the stored loan processing agreement corresponding to the identifier and also extracts the loan amount from the loan processing request. Loan management server 110 will process the loan processing request in accordance with one or more terms included in the loan processing agreement. In some embodiments, loan management server 110 extracts the preset loan limit included in the loan processing agreement and determines whether the loan amount of the current loan processing request (and in combination with one or more past loan processing requests associated with the same advertiser) complies with one or more predetermined rules configured for the preset loan limit. For example, a rule configured for the preset loan limit (e.g., a credit line) dictates that the sum of all loan amounts made to an advertiser (e.g., within a specific period) should not exceed the preset loan limit. If the rules configured for the preset loan limit are complied with, the loan management server 110 confirms that the loan amount included in the current loan processing request can be issued on behalf of the advertiser and loan management server 110 can initiate a transfer of funds equivalent to the loan amount to an account associated with publisher server 104 (and/or another entity), transfer funds equivalent to the loan amount to advertising management server 108 who will in turn transfer the funds to an account associated with publisher server 104, and/or send advertising management server 108 instructions associated with transferring the funds to an account associated with publisher server 104 (and/or another entity). However, if the rules configured for the preset loan limit are not complied with, the loan management server 110 does not permit a loan to the advertiser and sends a notification to advertising management server 108 that the loan processing request has failed/has not been successfully processed. In some embodiments, loan management server 110 is configured to maintain records of each loan amount issued to each advertiser and periodically sends to a device associated with the advertiser and/or advertising management server 108 a bill of the total loan amount that the advertiser is owed to the financial institution associated with loan management server 110.

Otherwise, if loan management server 110 determines that the identifier included in the loan processing request does not match a stored identifier, then loan management server 110 determines that the advertiser associated with the loan processing request is not a party with whom a loan processing request has previously been established and will therefore not process the loan processing request. In this case, in some embodiments, loan management server 110 may initiate sending the prompt configured to establish a loan processing agreement between the financial institution associated with loan management server 110 and the advertiser to a device associated with the advertiser, as described above.

In some embodiments, after publisher server 104 receives funds equivalent to the advertiser's total ad fees, publisher server 104 can send a payment complete message to advertising management server 108. For example, the funds received by publisher server 104 and/or at an account associated with publisher server 104 may have been transferred from the advertiser's advance deposit account, received from loan management server 110, or a combination of those two sources of funds. In response, advertising management server 108 can send publisher server 104 resume instructions (e.g., computer code) configured to cause publisher server 104 to resume display of the advertiser's ads, in the event that publisher server 104 was previously instructed to suspend their display.

As such, advertising management server 108 is configured to obtain payments (e.g., loans) as needed from loan management server 110 on behalf of one or more advertisers to ensure that the advertisers' ads can continue to run uninterrupted at one or more websites published by publisher server 104.

The following are two specific example applications of using system 100 to implement real-time advertisement payments for an advertiser:

1) Displaying CPC Ads at an E-Commerce Website

In this first example application, publisher server 104 operates an e-commerce website at which ads are displayed and a fee is charged to an advertiser each time one of the advertiser's ads is selected (e.g., clicked on) by a user. Examples of ads to be displayed at an e-commerce website include image-based and/or text-based ads. In this first example application, loan management server 110 is associated with a credit card company. Publisher server 104 acquires an ad (e.g., that was created by an advertising agency on behalf of an advertiser's marketing/promotional activities) that is provided by advertising management server 108 and presents it on a web page of the e-commerce website, which may be accessed and browsed by web page visitors. Publisher server 104 detects the signals generated from selection actions by web page visitors with respect to the displayed ads. Publisher server 104 collects data associated with visitor selection actions and sends the visitor selection action data to advertising management server 108.

Advertising management server 108 receives the visitor selection action data associated with one or more ads and uses the ads indicated in the selections to look up the corresponding advertiser(s). Advertising management server 108 determines the total ad fees owed by each identified advertiser based on the visitor selection action data and the fee that is charged for each visitor selection. In some embodiments, prior to looking up the corresponding advertiser(s), advertising management server 108 can compare the visitor selections to one or more predetermined rules and discard any visitor selections (e.g., determined to be potentially fraudulent) based on the comparison. In one scenario, if the advertiser has not set up an advance deposit account with advertising management server 108, advertising management server 108 treats the total ad fees as a desired credit payment charge and sends loan management server 110 a loan processing request including the total ad fees as the loan amount and an identifier associated with the relevant advertiser. In another scenario, if the advertiser has set up an advance deposit account with advertising management server 108, advertising management server 108 can first deduct funds from the advance deposit account to pay for the total ad fees. If there are sufficient funds from the advance deposit account to pay for all of the total ad fees, then there is no need to request a credit payment from loan management server 110. However, if there are not sufficient funds from the advance deposit account to pay for all of the total ad fees, then the difference between the total ad fees and the remaining funds in the advance deposit account (which will be applied towards the total ad fees) is determined as the loan amount/desired credit payment charge to be included in a loan processing request to loan management server 110. Put another way, the loan amount is determined using formula (1) below:

Loan Amount=Total Ad Fees−Remaining Funds in Advance Deposit Account (1)

Advertising management server 108 can store this loan amount/credit payment charge for the corresponding advertiser. Advertising management server 108 sends the loan processing request with the determined loan amount and an identifier of the relevant advertiser to loan management server 110. In some embodiments, advertising management server 108 may determine that it has not stored an identifier for the advertiser (meaning that the advertiser and the credit card company associated with loan management server 110 have not yet signed a credit/loan processing agreement and therefore the credit card company has not provided an identifier of the advertiser to be stored at advertising management server 108). If the identifier of the advertiser is not stored at advertising management server 108, advertising management server 108 can send a prompt to a device associated with the advertiser to request that the advertiser establish a loan processing agreement with the credit card company and/or send stop instructions to publisher server 104 to cause publisher server 104 to suspend displaying ads of the advertiser's. If the advertiser establishes the loan processing agreement with the credit card company via the prompt, then loan management server 110 generates an identifier for the advertiser, stores the identifier and the loan processing agreement, and sends at least the identifier to advertising management server 108 for advertising management server 108 to store. However, if the advertiser does not accept the loan processing agreement and/or cannot pay the total ad fees, then the advertiser's ads will no longer be displayed by publisher server 104.

Loan management server 110 receives the loan processing request sent from advertising management server 108. The advertiser identifier included in the loan processing request is compared with the advertiser identifiers stored by loan management server 110 and loan management server 110 determines whether a stored matching identifier can be found. If a matching identifier cannot be found at loan management server 110, then it indicates that the advertiser has not yet established a loan processing agreement with the credit card company associated with loan management server 110 and can refuse to process the loan processing request, or alternatively, loan management server 110 can send a prompt (e.g., either directly or via advertising management server 108) to a device associated with the advertiser to request the advertiser to establish the loan processing agreement with the credit card company, as described above. If the advertiser refuses to establish the loan processing agreement with the credit card company and is unable to pay the total ad fees in another manner (e.g., from the advertiser's advance deposit account), then the advertiser's ads will no longer be displayed by publisher server 104. Otherwise, if the advertiser agrees to establish the loan processing agreement with the credit card company, loan management server 110 will process the loan processing request. If loan management server 110 determines a matching identifier, the loan amount (e.g., the credit payment charge) is extracted from the loan processing request and the loan processing request is processed in accordance with the loan processing agreement between the advertiser and the credit card company. Loan management server 110 determines whether the loan amount of the current loan processing request can be authorized based on predetermined credit line rules. For example, a credit line rule requires that the total of the loan amounts requested for the advertiser (e.g., over a specific period) does not exceed the preset loan limit (i.e., preset credit line) included in the advertiser's loan processing agreement. Put another way, the credit line rule may be described by formula (2), below:

Preset Loan Limit (e.g., credit line)≧Current Loan Amount+Sum of All Previous Loan Amounts (2)

In other words, the amount that can still be loaned to the advertiser should be less than or equal to the advertiser's credit line less the sum of previous loan amounts (the advertiser's “existing credit balance”). The existing credit balance represents the remaining credit that the financial institution (e.g., the credit card company) can issue to the advertiser to pay for at least a portion of the total ad fees before the advertiser's credit line is met. For example, if an advertiser's preset loan limit is $10,000 and the advertiser has previously been issued $8,000 worth of loans, then the existing credit balance is ($10,000−$8,000)=$2,000. Therefore, in order for the loan amount from the current loan processing request to be authorized, the loan amount must be $2,000 or less. If loan management server 110 determines the loan amount is in compliance with the credit line rules, i.e., the existing credit balance is sufficient to pay this credit payment charge, loan management server 110 initiates a transfer of funds to the appropriate account(s) (e.g., of the publisher server 104 and/or advertising management server 108) to help the advertiser pay (or pays on its behalf) the outstanding ad fees. Loan management server 110 can track the total loan amount authorized for the advertiser and generate a bill (e.g., each month) and send it to a device associated with the advertiser, notifying the advertiser of the need to make a timely payment in accordance with the loan processing agreement and its repayment deadline, for example. If loan management server 110 determines the loan amount is not in compliance with the credit line rules, i.e., the existing credit balance is insufficient to pay this credit payment charge, loan management server 110 will refuse to pay the charge and sends a message to advertising management server 108 indicating the loan processing request could not be processed.

2) Displaying Sponsored Search Results by a Search Engine

In this second example, publisher server 104 operates a search engine and displays sponsored search results of an advertiser among search results in response to a user submitted search query. In some embodiments, the sponsored search results are displayed at a frequency and/or in a position among the search results determined based on display configurations associated with the advertiser. In some embodiments, sponsored search results are displayed either at top ranked positions among the ranked search results, in a different section from the other non-sponsored search results, and/or in another manner that is more conspicuous than the other non-sponsored search results. The search results are presented to and browsed by the searching user. Examples of sponsored search results are links (e.g., URLs) that direct to web pages associated with the advertiser. In this second example application, loan management server 110 is associated with a credit card company. Publisher server 104 collects user search queries and sends the user search queries to advertising management server 108.

Advertising management server 108 performs searches based on the received queries and sends at least the sponsored search results matching the search queries back to publisher server 104, which displays the search results in accordance with a priority sequence among other non-sponsored search results, i.e., in accordance with priority and/or exposure rate search result display configurations associated with the advertiser. (While advertising management server 108 may search specifically for sponsored search results, publisher server 104 can search for non-sponsored search results in response to a search query). For example, in accordance with such priority exposure rate search result display configurations, the sponsored search results will be granted priority and/or high-frequency display on the top of the first page of search results. Advertising management server 108 and/or publisher server 104 can keep track of each time that a sponsored search result is returned to and displayed by publisher server 104 and use the count of displayed sponsored search results and a fee that is charged to the advertiser for each instance of a displayed sponsored search result to calculate the total ad fees owed by the advertiser to advertising management server 108 and/or publisher server 104. In some embodiments, prior to determining the total ad fees, advertising management server 108 can compare the user search queries to one or more predetermined rules and discard any sponsored search result display data (e.g., determined to be potentially fraudulent) based on the comparison. Advertising management server 108 determines whether a loan amount from loan management server 110 is needed to cover any portion of the total ad fees in a manner similar to that described above for the first example application of 1) Displaying CPC Ads at an E-Commerce website. For example, if the advertiser does not accept/establish the loan processing agreement and/or cannot pay the total ad fees, then the priority and/or high-frequency display of its sponsored search results among the other non-sponsored search results will be discontinued (e.g., the sponsored search results may continue to be displayed among search results but no longer with priority ranking).

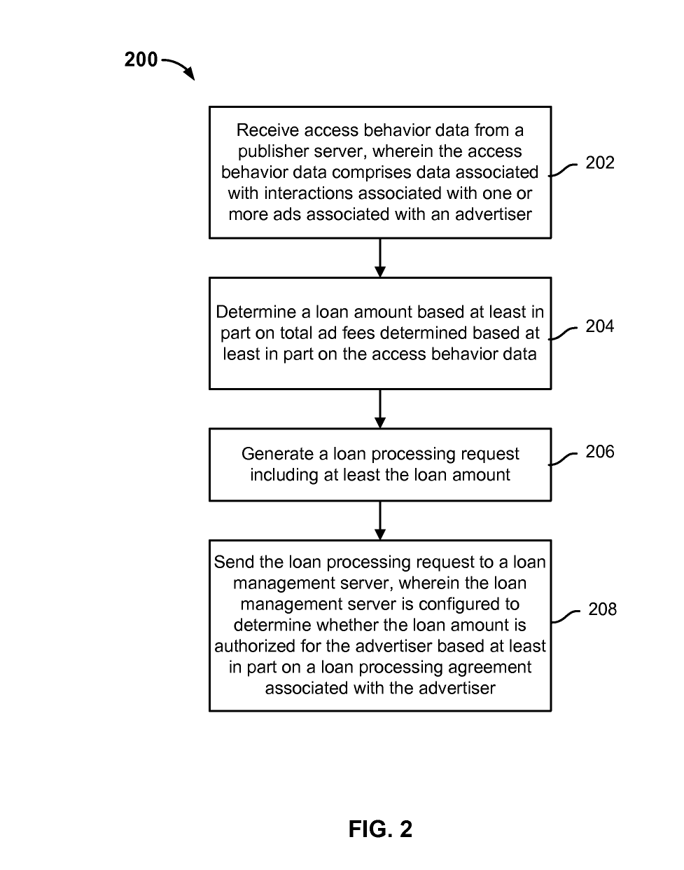

FIG. 2 is a flow diagram showing an embodiment of a process for obtaining real-time advertisement fee payments. In some embodiments, process 200 is implemented at an advertising management server such as advertising management server 108 of system 100 of FIG. 1.

At 202, access behavior data is received from a publisher server, wherein the access behavior data comprises data associated with interactions associated with one or more ads associated with an advertiser. In some embodiments, ads can be displayed at a publisher's website. In the first example of display CPC ads, a fee is charged to the advertiser each time that a user selects the advertiser's ad. In the second example of displaying sponsored search results by a search engine, a fee is charged to the advertiser each time that a sponsored search result is displayed in accordance with the priority and/or exposure rate search result display configurations associated with the advertiser. The publisher server collects access behavior data including the user selections and/or displays of sponsored search results and sends the access behavior data and data associated with the corresponding ads and/or advertisers to the advertising management server.

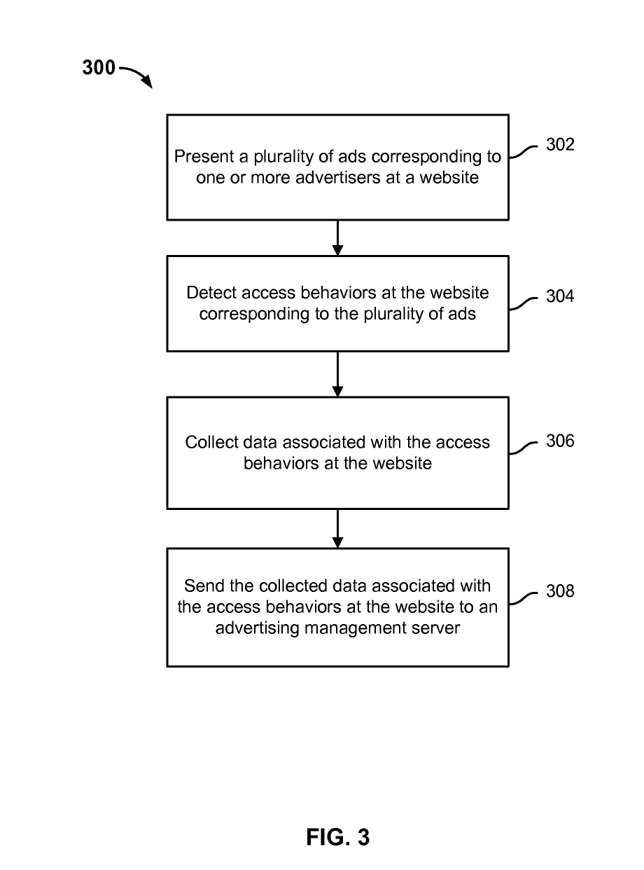

One example of a process by which a publisher server collects access behavior data is described with FIG. 3, below.

At 204, a loan amount is determined based at least in part on total ad fees determined based at least in part on the access behavior data. The advertising management server is configured to determine total ad fees owed by the advertiser to the publisher and/or the advertising management service based at least in part on the access behavior data received from the publisher server and/or the fee associated with each instance of each type of access behavior. The loan amount is determined as the total ad fees less any funds remaining in an advance deposit account associated with the advertiser, if such an account had been set up. The loan amount represents the amount of funds needed by the advertiser to pay for the total ad fees that it owes so that its ads can continue to be displayed by the publisher server.

At 206, a loan processing request including at least the loan amount is generated. The loan processing request (e.g., an HTTP request and/or an XML document) can be generated based on a format specified by the loan management server to which the request is to be sent. The loan processing request includes the loan amount and an identifier associated with the advertiser. In some embodiments, the advertising management server stores identifiers (generated by and received from the loan management server) corresponding to one or more advertisers.

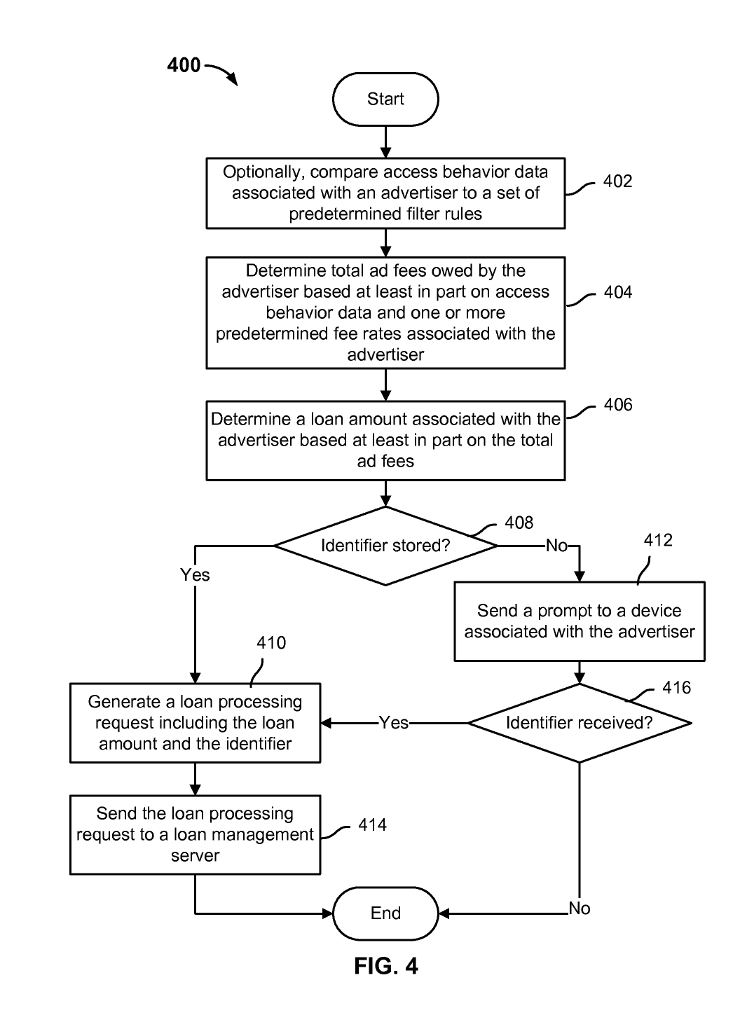

One example of a process by which an advertising management server determines the loan amount and generates the loan processing request is described with FIG. 4 below.

At 208, the loan processing request is sent to a loan management server, wherein the loan management server is configured to determine whether the loan amount is authorized for the advertiser based at least in part on a loan processing agreement associated with the advertiser. The loan processing request is sent to the loan management server, which determines whether the loan amount for the advertiser should be authorized based at least in part on a loan processing agreement that was established between the advertiser and the financial institution associated with the loan management server. An identifier included in the loan processing request is usable by the loan management server to identify the appropriate loan processing agreement. If the loan management server determines that the loan amount can be authorized/issued to the advertiser, in some embodiments, the loan management server sends the funds associated with the loan amount to the advertising management server and/or instructions configured to enable the advertising management server to access such funds.

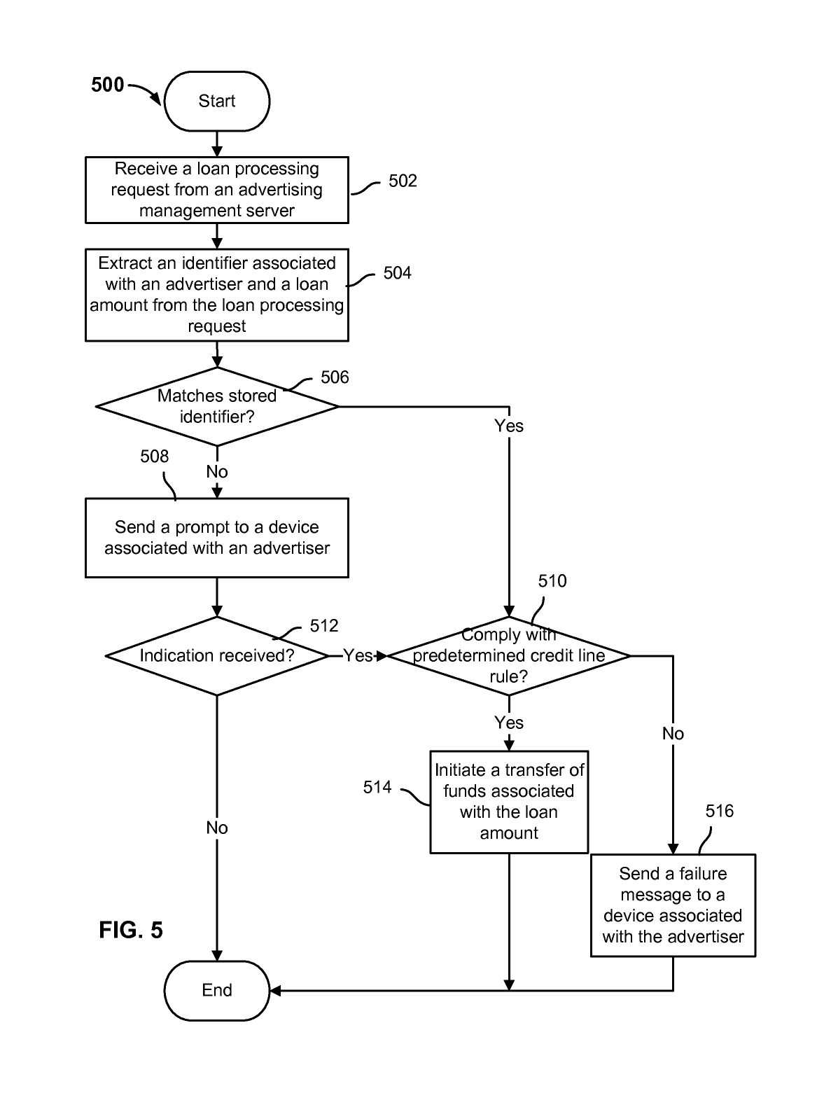

One example of a process by which a loan management server processes the loan processing request is described with FIG. 5 below.

FIG. 3 is a flow diagram showing an example of a process for collecting access behavior data. In some embodiments, process 300 is implemented at a publisher server such as publisher server 104 of system 100 of FIG. 1.

Process 300 describes an example process by which a publisher server can collect access behavior data at one or more websites that it operates and send the access behavior data to an advertising management server (e.g., such as described with step 202 of process 200 of FIG. 2, in which an advertising management server receives access behavior data from a publisher server).

At 302, a plurality of ads corresponding to one or more advertisers is presented at a website. In a first example, if the website comprises an e-commerce website, ads such as image-based ads, text-based ads, and/or video-based ads can be displayed at the e-commerce's home page and/or at the profile pages of one or more products. In a second example, if the website comprises a search engine website, ads such as sponsored search results can be displayed at priority ranking positions and/or in a configured area of a search results page.

At 304, access behaviors at the website corresponding to the plurality of ads are detected. User interactions/events and/or publisher initiated interactions/events associated with the ads are detected by the publisher server (e.g., based on signals that are generated based on the interactions). Returning to the first example, if the website comprises an e-commerce website, user selections on the displayed ads comprises access behaviors that can be detected by the publisher server. Returning to the second example, if the website comprises a search engine website, displays of sponsored search results in response to user submitted queries can be detected by the publisher server.

At 306, data associated with the access behaviors at the website is collected. Data associated with the detected access behaviors is collected and stored by the publisher server. For example, data associated with an access behavior can include identifying data associated with the ad with which the access behavior is associated, identifying data associated with the advertiser with which the access behavior is associated, and/or a time indication at which the access behavior occurred.

At 308, the collected data associated with the access behaviors are sent to an advertising management server. For example, the access behavior data can be sent to one or more advertising management servers that provide ad fee payments on behalf of one or more advertisers associated with the ads with which the access behavior data is associated.

FIG. 4 is a flow diagram showing an example of a process for generating a loan processing request. In some embodiments, process 400 is implemented at an advertising management server such as advertising management server 108 of system 100 of FIG. 1.

Process 400 describes an example process by which an advertising management server can generate a loan processing request on behalf of an advertiser. In some embodiments, steps 204 and 206 of process 200 of FIG. 2 can be implemented using process 400. In some embodiments, the advertising management server can extract the subset of the access behavior data associated with each advertiser and perform process 400 on each advertiser's subset of access behavior data.

At 402, optionally, access behavior data associated with an advertiser is compared to a set of predetermined filter rules. In some embodiments, one or more predetermined filter rules can be compared to the access behavior data to identify potentially fraudulent data. For example, a predetermined filter rule comprises a pattern associated with a fraudulent access behavior and therefore, the access behaviors that match a predetermined filter rule can be determined to be potentially fraudulent and therefore discarded (i.e., not included in the determination of total ad fees owed by the advertiser).

At 404, total ad fees owed by the advertiser are determined based at least in part on the access behavior data and one or more predetermined fee rates associated with the advertiser. In some embodiments, one or more predetermined fee rates are stored for each advertiser. A predetermined fee rate can be established between the advertiser and the publisher and/or the advertising management service. A predetermined fee rate indicates the fee that is charged for each instance of each type of access behavior (e.g., what fee should be charged for each user selection on an ad or each display of a sponsored search result by the publisher) of an ad associated with the advertiser. The fee can be paid to the publisher and/or the advertising management service. The total ad fees owed by the advertiser can be determined as a function of the predetermined fee rates and the counts of each type of access behavior.

At 406, a loan amount associated with the advertiser is determined based at least in part on the total ad fees. In some embodiments, the advertising management server checks whether the advertiser has set up an advance deposit account and if so, whether any funds remain in the account. If no advance deposit account has been set up and/or an advance deposit account has been set up but includes no funds, then it is determined that the advertiser needs to receive a loan amount equivalent to the total ad fees. However, if an advance deposit account has been set up and the account includes funds, then it is determined whether the funds in the account are at least equal to the total ad fees. If the funds in the advance deposit account are not at least equal to the total ad fees, then it is determined that the advertiser needs to receive a loan amount equivalent to the difference between the total ad fees and the amount of funds in the account.

Otherwise, if the funds in the advance deposit account are at least equal to the total ad fees, then it is determined that the advertiser has sufficient funds in its advance deposit account to pay for the entirety of the total ad fees and therefore no loan is needed and a loan processing request is not generated.

The advertising management server can store the loan amount associated with other data stored for the advertiser (e.g., previous loan amounts determined for the advertiser).

At 408, it is determined whether an identifier associated with the advertiser is stored by the advertising management server. If an identifier is stored for the advertiser by the advertising management server, then it indicates that a loan processing agreement exists between the advertiser and a financial institution (e.g., a credit card company) associated with a loan management server to which the loan processing request is to be sent.

In the event that the identifier associated with the advertiser is stored, control is transferred to 410. Otherwise, in the event that the identifier associated with the advertiser is not stored, control is transferred to 412.

At 410, a loan processing request including the loan amount and the identifier is generated.

At 414, the loan processing request is sent to a loan management server.

At 412, a prompt configured to establish a loan processing agreement between the advertiser and a financial institution associated with a loan management server is sent to a device associated with the advertiser. The advertising management server can send a prompt comprising computer program code for a user interface and/or a URL directed to a web page with which the advertiser can interact (e.g., via selecting a button) to establish a loan processing agreement with the financial institution. In some embodiments, the advertising management server can also send stop instructions to a publisher server associated with running the advertiser's ads to suspend the display of the ads and/or the display of the ads in a priority and/or high frequency manner.

At 416, it is determined whether a newly generated identifier associated with the advertiser is received from the loan management server. If a newly generated identifier associated with the advertiser is received from the loan management server, it is determined that the advertiser has established the loan processing agreement with the financial institution and as a result, the loan management server generated an identifier (e.g., based on a portion of the loan processing agreement) and sent the identifier to the advertising management server. The loan processing request can then be generated based on the loan amount and the newly generated identifier associated with the advertiser. In some embodiments, if the advertising management server had previously sent stop instructions to the publisher server, the advertising management server can send resume instructions to the publisher server to cause the publisher server to resume display of the ads and/or the display of the ads in a priority and/or high frequency manner.

However, if no newly generated identifier associated with the advertiser is received from the loan management server (e.g., within a configured period of time since the prompt was sent to the device associated with the advertiser), it is determined that the advertiser has not established the loan processing agreement with the financial institution and therefore, the loan processing request will not be generated and process 400 ends.

In the event that the newly generated identifier associated with the advertiser is received from the loan management server, control is transferred to 410. Otherwise, in the event that the newly generated identifier associated with the advertiser is not received from the loan management server, process 400 ends. In some embodiments, in the event that the newly generated identifier associated with the advertiser is not received from the loan management server, the advertising management server sends a failure message to the device associated with the advertiser to indicate that the outstanding total ad fees could not be paid using a loan. The advertising management server can also send stop instructions to the publisher server associated with displaying the advertiser's ads to suspend the display of the ads and/or the display of the ads in a priority and/or high frequency manner.

FIG. 5 is a flow diagram showing an example of a process for processing a loan processing request. In some embodiments, process 500 is implemented at a loan management server such as loan management server 110 of system 100 of FIG. 1.

Process 500 shows an example process by which a loan management server associated with a financial institution processes a loan processing request received from an advertising management server (e.g., such as described with step 208 of process 200 of FIG. 2, in which an advertising management server sends a loan processing request to the loan management server).

At 502, a loan processing request is received from an advertising management server.

At 504, an identifier associated with an advertiser and a loan amount are extracted from the loan processing request.

At 506, it is determined whether the extracted identifier matches a stored identifier. As described above, an identifier is generated by the loan management server based on a loan processing agreement established between an advertiser and the financial institution associated with the loan management server. The loan management server is configured to store the identifier and also send the identifier to the advertising management server for the advertising management server to store. If the loan management server determines that the identifier extracted from the loan processing request matches an identifier stored by the loan management server, the loan management server determines that the advertiser associated with the identifier is an authorized and credible party with which the financial institution has previously established a loan processing agreement. Otherwise, if the loan management server determines that the identifier extracted from the loan processing request does not match an identifier stored by the loan management server, the loan management server determines that the advertiser associated with the identifier is not an authorized and credible party with which the financial institution has previously established a loan processing agreement.

In the event that the extracted identifier matches a stored identifier, control is transferred to 510. Otherwise, in the event that the extracted identifier does not match a stored identifier, control is transferred to 508.

At 508, a prompt configured to establish a loan processing agreement between the advertiser and a financial institution associated with the loan management server is sent to a device associated with an advertiser. In some embodiments, the loan management server sends the prompt to the device associated with the advertiser. In some embodiments, the loan management server sends data associated with the prompt to an advertising management server and the advertising management server in turn sends the prompt to the device associated with the advertiser. As described above, the prompt includes a control (e.g., an “Agree” button) with which the advertiser can interact to agree to establish a loan processing agreement with the financial institution.

At 512, it is determined whether an indication associated with an establishment of the loan processing agreement has been received. In some embodiments, in response to the advertiser selecting to agree to establish the loan processing request with the financial institution, a corresponding indication is received at the loan management server. However, if the advertiser does not select to agree to establish the loan processing request with the financial institution, no indication is received at the loan management server and/or a failure message is received at the loan management server and the loan processing request is not processed.

In the event that the indication to establish the loan processing agreement has been received, control is transferred to 510. Otherwise, in the event that the indication to establish the loan processing agreement is not received (e.g., within a specified period), process 500 ends.

At 510, it is determined whether the loan amount included in the loan processing request complies with a predetermined credit line rule based at least in part on a loan processing agreement associated with the identifier. The identifier extracted from the loan processing request is used to identify a stored loan processing agreement. The loan processing agreement includes a preset loan limit, which can be a credit line, for example. For example, a credit line rule requires that the total of the loan amounts requested for the advertiser (e.g., over a specific period) does not exceed the preset loan limit (i.e., preset credit line) included in the advertiser's loan processing agreement. In other words, the amount that can still be loaned to the advertiser should be less than or equal to the advertiser's credit line less the sum of previous loan amounts (the advertiser's “existing credit balance”). Therefore, if the loan amount extracted from the loan processing request is equal to or less than the existing credit balance, then the credit line rule is complied with and the loan amount should be authorized to the advertiser. However, if the loan amount extracted from the loan processing request is greater than the existing credit balance, then the credit line rule is not complied with and the loan is not authorized.

In the event that the predetermined credit line rule is complied with, control is transferred to 514. Otherwise, in the event that the predetermined credit line rule is not complied with, control is transferred to 516.

At 514, a transfer of funds associated with the loan amount is initiated. In some embodiments, the loan management server initiates a transfer of funds to the appropriate account (e.g., the publisher server and/or the advertising management server) to help the advertiser pay (or pays on its behalf) the outstanding ad fee. This transfer of funds equivalent to the loan amount and, if applicable, in combination with any funds withdrawn from the advertiser's advance deposit account equals the total ad fees. The loan management server can keep track of the loan amounts authorized to each advertiser and periodically send a bill to each of the devices of each advertiser for the total loan amount (e.g., over a specific period) owed by the advertiser to the financial institution associated with the loan management server.

At 516, a failure message is sent to a device associated with the advertiser. The failure message indicates that the loan management server was not able to authorize the loan amount and therefore, at least a portion of the total ad fees remains outstanding. In some embodiments, the loan management server can also send stop instructions to the publisher server associated with displaying the advertiser's ads to suspend the display of the ads and/or the display of the ads in a priority and/or high frequency manner.

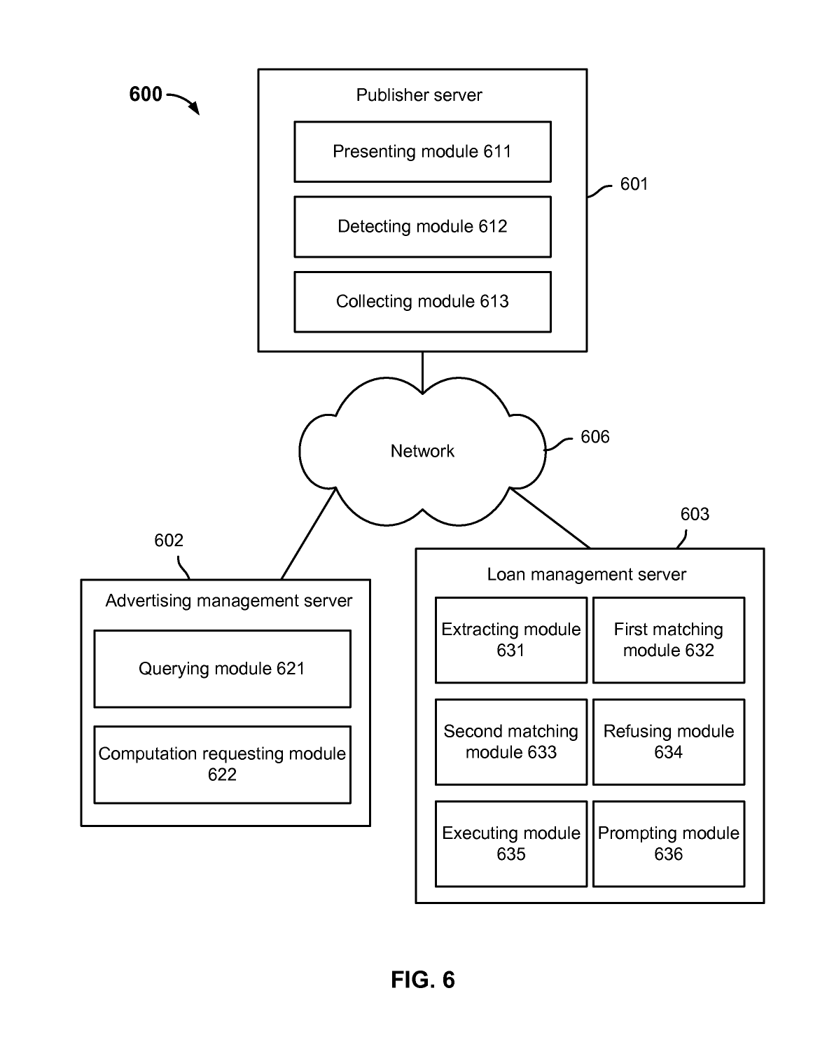

FIG. 6 is a flow diagram showing an embodiment of obtaining real-time advertisement fee payments. In the example, system 600 includes publisher server 601, network 606, advertising management server 602, and loan management server 603. Network 606 includes high-speed data networks and/or telecommunications networks.

The modules can be implemented as software components executing on one or more processors, as hardware such as programmable logic devices, and/or Application Specific Integrated Circuits designed to elements can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The modules may be implemented on a single device or distributed across multiple devices.

Publisher server 601 includes presenting module 611, detecting module 612, and collecting module 613. In some embodiments, publisher server 601 can be used to implement publisher server 104 of system 100 of FIG. 1.

Presenting module 611 is configured to present one or more ads at a publisher's website.

Detecting module 612 is configured to detect the signals generated from access behaviors with respect to the ads.

Collecting module 613 is configured to collect access behavior data associated with the detected access behaviors.

Publisher server 601 is configured to send the collected access behavior data to advertising management server 602.

Advertising management server 602 includes querying module 621 and computation requesting module 622. In some embodiments, advertising management server 602 can be used to implement advertising management server 108 of system 100 of FIG. 1.

Querying module 621 is configured to identify one or more advertisers associated with the ads associated with the access behavior data received from publisher server 601.

Computation requesting module 622 is configured to determine total ad fees owed by each advertiser identified by querying module 621 based on the access behavior data. Computation requesting module 622 is configured to further determine the loan amount corresponding to each advertiser based at least in part on the advertiser's total ad fees. Computation requesting module 622 is configured to generate a loan processing request corresponding to an advertiser including an identifier associated with the advertiser and the loan amount. Advertising management server 602 is configured to send the loan processing request to loan management server 603.

Loan management server 603 includes extracting module 631, first matching module 632, second matching module 633, refusing module 634, executing module 635, and prompting module 636. In some embodiments, loan management server 603 can be used to implement loan management server 110 of system 100 of FIG. 1.

Extracting module 631 is configured to extract an identifier and a loan amount from a loan processing request received from advertising management server 602. The identifier can be used to identify a stored loan processing agreement between the advertiser and a financial institution associated with loan management server 603.

First matching module 632 is configured to determine whether the identifier extracted from the loan processing request matches a stored identifier. If a matching stored identifier can be found, then it indicates that the advertiser is an authorized party that has previously established a loan processing agreement with the financial institution and may receive loans from the financial institution. Otherwise, if a matching stored identifier cannot be found, then it indicates that the advertiser is not authorized to receive loans from the financial institution.

Second matching module 633 is configured to determine whether the loan amount extracted from the loan processing request complies with a predetermined credit line rule based at least in part on a portion (e.g., the preset loan limit) of the loan processing agreement identified by the identifier extracted from the loan processing request. If the loan amount complies with the credit line rule, then the advertiser is able to receive a loan from the financial institution. Otherwise, if the loan amount does not comply with the credit line rule, then the advertiser is not able to receive a loan from the financial institution.

Refusing module 634 is configured to deny the loan to the advertiser in the event that the identifier extracted from the loan processing request does not match a stored identifier and/or the loan amount extracted from the loan processing request does not comply with a predetermined credit line rule.

Executing module 635 is configured to initiate transfer of funds associated with the loan amount in the event that the identifier extracted from the loan processing request matches a stored identifier and/or the loan amount extracted from the loan processing request complies with a predetermined credit line rule.

Prompting module 636 is configured to send a prompt to a device associated with the advertiser to establish a loan processing agreement between the advertiser and the financial institution in the event that the identifier extracted from the loan processing request does not match a stored identifier.

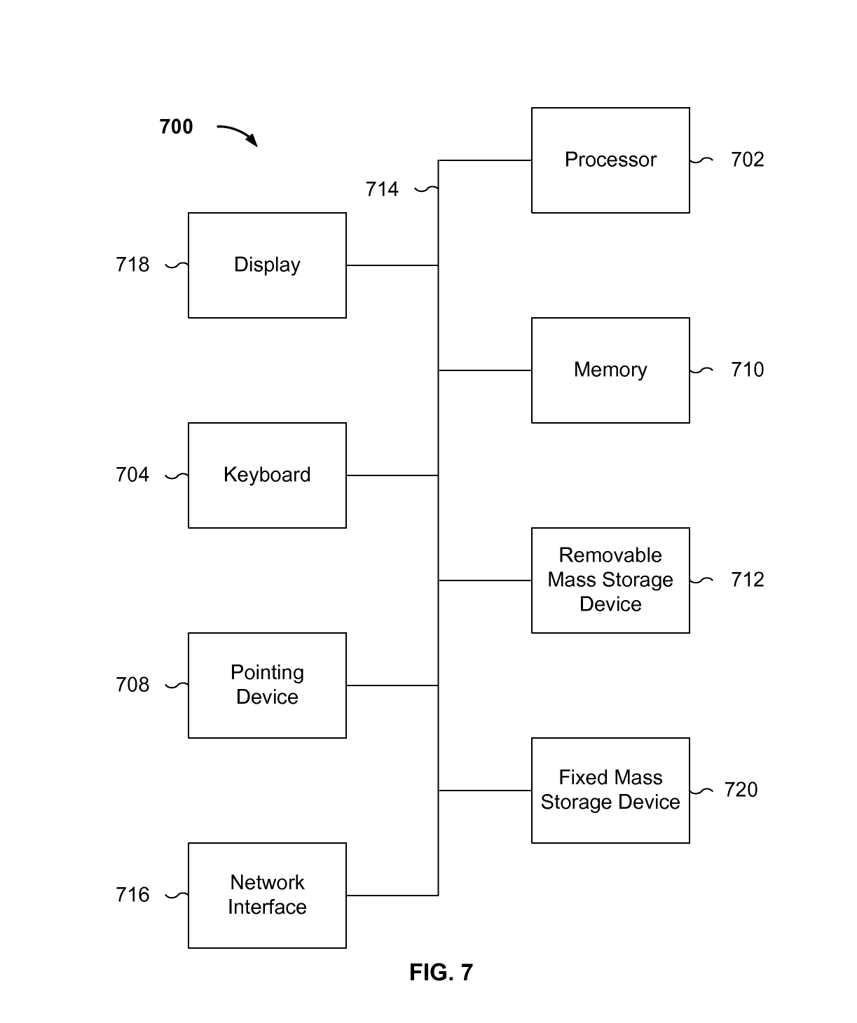

FIG. 7 is a functional diagram illustrating an embodiment of a programmed computer system for implementing the obtaining of real-time advertisement fee payments. As will be apparent, other computer system architectures and configurations can be used to determine message data to present based on a message. Computer system 700, which includes various subsystems as described below, includes at least one microprocessor subsystem (also referred to as a processor or a central processing unit (CPU)) 702. For example, processor 702 can be implemented by a single-chip processor or by multiple processors. In some embodiments, processor 702 is a general purpose digital processor that controls the operation of the computer system 700. Using instructions retrieved from memory 710, the processor 702 controls the reception and manipulation of input data, and the output and display of data on output devices (e.g., display 718). In some embodiments, processor 702 includes and/or is used to provide obtainment of real-time advertisement fee payments.

Processor 702 is coupled bi-directionally with memory 710, which can include a first primary storage area, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 702. Also as is well known in the art, primary storage typically includes basic operating instructions, program code, data, and objects used by the processor 702 to perform its functions (e.g., programmed instructions). For example, memory 710 can include any suitable computer readable storage media, described below, depending on whether, for example, data access needs to be bi-directional or uni-directional. For example, processor 702 can also directly and very rapidly retrieve and store frequently needed data in a cache memory (not shown).

A removable mass storage device 712 provides additional data storage capacity for the computer system 700 and is coupled either bi-directionally (read/write) or uni-directionally (read only) to processor 702. For example, storage 712 can also include computer readable media such as magnetic tape, flash memory, PC-CARDS, portable mass storage devices, holographic storage devices, and other storage devices. A fixed mass storage 720 can also, for example, provide additional data storage capacity. The most common example of fixed mass storage 720 is a hard disk drive. Mass storage 712, 720 generally store additional programming instructions, data, and the like that typically are not in active use by the processor 702. It will be appreciated that the information retained within mass storage 712 and 720 can be incorporated, if needed, in standard fashion as part of memory 710 (e.g., RAM) as virtual memory.

In addition to providing processor 702 access to storage subsystems, bus 714 can also be used to provide access to other subsystems and devices. As shown, these can include a display 718, a network interface 716, a keyboard 704, and a pointing device 708, as well as an auxiliary input/output device interface, a sound card, speakers, and other subsystems as needed. For example, the pointing device 708 can be a mouse, stylus, track ball, or tablet, and is useful for interacting with a graphical user interface.

The network interface 716 allows processor 702 to be coupled to another computer, computer network, or telecommunications network using a network connection as shown. For example, through the network interface 716, the processor 702 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 702 can be used to connect the computer system 700 to an external network and transfer data according to standard protocols. For example, various process embodiments disclosed herein can be executed on processor 702, or can be performed across a network such as the Internet, intranet networks, or local area networks, in conjunction with a remote processor that shares a portion of the processing. Additional mass storage devices (not shown) can also be connected to processor 702 through network interface 716.

An auxiliary I/O device interface (not shown) can be used in conjunction with computer system 700. The auxiliary I/O device interface can include general and customized interfaces that allow the processor 702 to send and, more typically, receive data from other devices such as microphones, touch-sensitive displays, transducer card readers, tape readers, voice or handwriting recognizers, biometrics readers, cameras, portable mass storage devices, and other computers.

Computer-readable media, including permanent and non-permanent and removable and non-removable media, may achieve information storage by any method or technology. Information can be computer-readable commands, data structures, program modules, or other data. Examples of computer storage media include but are not limited to phase-change memory (PRAM), static random access memory (SRAM), dynamic random access memory (DRAM), other types of random access memory, read-only memory (ROM), electrically erasable programmable read-only memory (EEPROM), flash memory, or other memory technology, CD-ROM, digital multifunction disc (DVD) or other optical storage, magnetic cassettes, magnetic tape or magnetic disc memory, or other magnetic storage equipment or any other non-transmission media that can be used to store information that is accessible to computers. As used herein, computer-readable media does not include transitory computer-readable media, such as modulated data signals and carrier waves.

The present application can be described in the general context of computer executable commands executed by a computer, such as a program module or unit. Generally, program modules or units include routines, programs, objects, components, data structures, etc. to execute specific tasks or implement specific abstract data types. Generally, program modules or units can be realized through software, hardware, or combinations of the two. The present application can also be carried out in distributed computing environments; in such distributed computing environments, tasks are executed by remote processing equipment connected via communication networks. In distributed computing environments, program modules or units can be located on storage media at local or remote computers that include storage equipment.

A person skilled in the art should understand that the embodiments of the present application can be provided as methods, devices, or computer software products. Therefore, the present application may take the form of complete hardware embodiments, complete software embodiments, or embodiments that combine software and hardware. In addition, the present application can take the form of computer program products implemented on one or more computer-operable storage media (including but not limited to magnetic disk storage devices, CD-ROMs, and optical storage devices) containing computer operable program codes.

This document has employed specific embodiments to expound the principles and forms of implementation of the present application. The above embodiment explanations are only meant to aid in comprehension of the methods of the present application and of its main concepts. Moreover, a person with general skill in the art would, on the basis of the concepts of the present application, be able to make modifications to specific forms of implementation and to the scope of applications. To summarize the above, the contents of this description should not be understood as limiting the present application.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. An advertising management server, comprising:
one or more processors configured to:
receive access behavior data from a publisher server, wherein the access behavior data comprises data associated with interactions associated with one or more ads associated with an advertiser;
determine a loan amount based at least in part on total ad fees determined based at least in part on the access behavior data;
generate a loan processing request including at least the loan amount; and
send the loan processing request to a loan management server, wherein the loan management server is configured to determine whether the loan amount is authorized for the advertiser based at least in part on a loan processing agreement associated with the advertiser; and
one or memories coupled to the one or more processors and configured to provide the one or more processors with instructions.

2. The advertising management server of claim 1, wherein the access behavior data comprises data associated with user selections or publisher initiated events.

3. The advertising management server of claim 1, wherein the total ad fees are determined based at least in part on the access behavior data and a predetermined fee rate.

4. The advertising management server of claim 1, wherein determining the loan amount based at least in part on the total ad fees includes to:
determine an amount of funds remaining in an advance deposit account associated with the advertiser; and
determine the loan amount based at least in part on the total ad fees and the amount of funds remaining in the advance deposit account associated with the advertiser.

5. The advertising management server of claim 1, wherein generating the loan processing request further includes to:
determine whether an identifier associated with the advertiser is stored;
in the event that the identifier associated with the advertiser is stored, include the identifier associated with the advertiser in the loan processing request; and
in the event that the identifier associated with the advertiser is not stored:
send a prompt to a device associated with the advertiser, wherein the prompt is configured to establish the loan processing agreement between the advertiser and a financial institution associated with the loan management server; and
send stop instructions to the publisher server, wherein the stop instructions are configured to cause the publisher server to suspend display of the one or more ads.

6. The advertising management server of claim 5, wherein the one or more processors are further configured to:
receive an indication associated with the establishment of the loan processing agreement; and
in response to the indication, send resume instructions to the publisher server, wherein the resume instructions are configured to cause the publisher server to resume display of the one or more ads.

7. The advertising management server of claim 5, wherein the one or more processors are further configured to:
receive a newly generated identifier associated with the advertiser from the loan management server;
store the newly generated identifier; and
include the newly generated identifier associated with the advertiser in the loan processing request.

8. A method, comprising:
receiving access behavior data from a publisher server, wherein the access behavior data comprises data associated with interactions associated with one or more ads associated with an advertiser;
determining, using one or more processors, a loan amount based at least in part on total ad fees determined based at least in part on the access behavior data;
generating a loan processing request including at least the loan amount; and
sending the loan processing request to a loan management server, wherein the loan management server is configured to determine whether the loan amount is authorized for the advertiser based at least in part on a loan processing agreement associated with the advertiser.

9. The method of claim 8, wherein the access behavior data comprises data associated with user selections or publisher initiated events.

10. The method of claim 8, wherein the total ad fees are determined based at least in part on the access behavior data and a predetermined fee rate.

11. The method of claim 8, wherein determining the loan amount based at least in part on the total ad fees includes:
determining an amount of funds remaining in an advance deposit account associated with the advertiser; and
determining the loan amount based at least in part on the total ad fees and the amount of funds remaining in the advance deposit account associated with the advertiser.

12. The method of claim 8, wherein generating the loan processing request further includes:
determining whether an identifier associated with the advertiser is stored;
in the event that the identifier associated with the advertiser is stored, including the identifier associated with the advertiser in the loan processing request; and
in the event that the identifier associated with the advertiser is not stored:
sending a prompt to a device associated with the advertiser, wherein the prompt is configured to establish the loan processing agreement between the advertiser and a financial institution associated with the loan management server; and
sending stop instructions to the publisher server, wherein the stop instructions are configured to cause the publisher server to suspend display of the one or more ads.

13. The method of claim 12, further comprising:
receiving an indication associated with the establishment of the loan processing agreement; and
in response to the indication, sending resume instructions to the publisher server, wherein the resume instructions are configured to cause the publisher server to resume display of the one or more ads.

14. The method of claim 12, further comprising:
receiving a newly generated identifier associated with the advertiser from the loan management server;
storing the newly generated identifier; and
including the newly generated identifier associated with the advertiser in the loan processing request.

15. A publisher server, comprising:
one or more processors configured to:
present a plurality of ads corresponding to one or more advertisers at a website;
detect access behaviors at the website corresponding to the plurality of ads;
collect data associated with the access behaviors at the website; and
send the collected data associated with the access behaviors at the website to an advertising management server; and
one or more memories coupled to the one or more processors and configured to provide the one or more processors with instructions.

16. The publisher server of claim 15, wherein the website comprises an e-commerce website.

17. The publisher server of claim 15, wherein the website comprises a search engine website.

18. A loan management server, comprising:
one or more processors configured to:
receive a loan processing request from an advertising management server;
extract an identifier associated with an advertiser and a loan amount from the loan processing request;
retrieve a loan processing agreement associated with the identifier; and
determine whether the loan amount complies with a predetermined credit line rule based at least in part on the loan processing agreement; and
one or more memories coupled to the one or more processors and configured to provide the one or more processors with instructions.

19. The loan management server of claim 18, wherein determining whether the loan amount complies with the predetermined credit line rule based at least in part on the loan processing agreement includes determining whether a difference between a preset loan limit included in the loan processing agreement and a sum of one or more past loan amounts issued to the advertiser is equal to or greater than the loan amount.

20. The loan management server of claim 18, wherein in the event that the loan amount complies with the predetermined credit line rule, the one or more processors are further configured to initiate a transfer of funds associated with the loan amount.
